(19) United States
(12) Patent Application Publication
(10) Pub. No.: US 2007/0127066 A1
(43) Pub. Date: Jun. 7, 2007

(54) Image forming apparatus and recording medium

(75) Inventor: Kenya Haba, Toyokawa-shi (JP)

Correspondence Address: BUCHANAN, INGERSOLL & ROONEY PC, POST OFFICE BOX 1404, ALEXANDRIA, VA, 22313-1404, US

(73) Assignee: Konica Minolta Business Technologies Inc., Tokyo (JP)

(21) Appl. No.: 11/582,389

(22) Filed: Oct. 18, 2006

(30) Foreign Application Priority Data
Dec. 7, 2005 (JP) 2005-354145

(51) Int. Cl. G06F 3/12

(52) U.S. Cl. 358/1.15; 358/1.14

(57) ABSTRACT

An image forming apparatus as a backup origin image forming apparatus, comprises a storing portion configured to store output performance information of a plurality of other image forming apparatuses as backup destination candidate apparatuses connected to the backup origin image forming apparatus via a network, a comparing-selecting portion configured to compare the stored output performance information of each of the plurality of other image forming apparatuses and output performance information of the backup origin image forming apparatus and select an image forming apparatus having output performance equivalent to or better than the output performance of the backup origin image forming apparatus as a data backup destination apparatus from the plurality of other image forming apparatuses as the backup destination candidate apparatuses based on the comparison result, and a transmitting portion configured to transmit backup target data to the image forming apparatus selected as the data backup destination apparatus by the comparing-selecting portion.

This application claims priority under 35 U.S.C. § 119 to Japanese Patent Application No. 2005-354145 filed on Dec. 7, 2005, the entire disclosure of which is incorporated herein by reference in its entirety.

### BACKGROUND OF THE INVENTION

1. Field of the Invention

The present invention relates to an image forming apparatus, such as a printer, a copying machine, or a complex machine, connected to a plurality of image forming apparatuses via a network. It also relates to a backup processing program for making a computer execute backup processing of backup target data of the aforementioned image forming apparatus to thereby store the data in a backup destination image forming apparatus.

2. Description of the Related Art

The following description sets forth the inventor's knowledge of related art and problems therein and should not be construed as an admission of knowledge in the prior art.

In a conventional image forming apparatus connected to a network, it is conventionally known to store image data, such as facsimile (hereinafter referred to as “FAX”) data, print data or scanned data, in a hard disk device (hereinafter referred to as “HDD”) of the image forming apparatus to reuse the data.

In the case of using a HDD which is a typical memory storage of an image forming apparatus, because of its mechanical structure, there is a possibility of a partial destruction or a total loss of the stored data at the time of the breakage of the HDD itself, etc. Under the circumstances, in Japanese Unexamined Laid-open Patent Publication No. 2004-230617, it is proposed to regularly execute data backup of an image forming apparatus using a HDD of a printer or the like connected to the same network for recovery of the data to thereby enhance the safety of stored data in the image forming apparatus.

On the other hand, in Japanese Unexamined Laid-open Patent Publication No. 2000-330752, it is proposed to effectively utilize a memory of an image forming apparatus by temporarily transferring the data to another printer to avoid the delay of printing because of an insufficient memory due to the increased amount of data to be stored in a printer for various functions.

In executing data backup among image forming apparatuses connected to a network, if the backup is executed in a state in which the output performance of the backup destination image forming apparatus is unknown, in cases where it is required to output the backup data by the backup destination image forming apparatus for the reason of, e.g., the malfunction of the backup origin image forming apparatus, there is a possibility that the output performance equivalent to the backup origin image forming apparatus cannot be secured, resulting in inconvenience of users. For example, in cases where the backup destination image forming apparatus has print quality performance inferior to the print quality performance of the backup origin image forming apparatus, there is such a problem that only an output poor in print quality can be obtained.

The aforementioned Japanese Unexamined Laid-open Patent Publication No. 2004-230617, however, was silent about the technique regarding the selection of backup destination image forming apparatuses. On the other hand, in the technique disclosed in the aforementioned Japanese Unexamined Laid-open Patent Publication No. 2000-330752, the backup destination image forming apparatus is selected based on a remaining memory level. Thus, neither of them could give a solution to the aforementioned problems that the output performance of the backup origin image forming apparatus could not be secured.

The description herein of advantages and disadvantages of various features, embodiments, methods, and apparatus disclosed in other publications is in no way intended to limit the present invention. Indeed, certain features of the invention may be capable of overcoming certain disadvantages, while still retaining some or all of the features, embodiments, methods, and apparatus disclosed therein.

### SUMMARY OF THE INVENTION

The preferred embodiments of the present invention have been developed in view of the above-mentioned and/or other problems in the related art. The preferred embodiments of the present invention can significantly improve upon existing methods and/or apparatuses.

Among other potential advantages, some embodiments can provide an image forming apparatus capable of securing output performance equivalent to the output performance of a backup origin image forming apparatus at the time of outputting backup data from a backup destination image forming apparatus, thereby enhancing user convenience.

Among other potential advantages, some embodiments can provide a recording medium in which a backup processing program for making a computer of an image forming apparatus execute backup processing is stored.

According to a first aspect of the preferred embodiment of the present invention, an image forming apparatus as a backup origin image forming apparatus comprises:

a storing portion configured to store output performance information of a plurality of other image forming apparatuses as backup destination candidate apparatuses connected to the backup origin image forming apparatus via a network;

a comparing-selecting portion configured to compare the stored output performance information of each of the plurality of other image forming apparatuses and output performance information of the backup origin image forming apparatus and select an image forming apparatus having output performance equivalent to or better than the output performance of the backup origin image forming apparatus as a data backup destination apparatus from the plurality of other image forming apparatuses as the backup destination candidate apparatuses based on the comparison result; and

a transmitting portion configured to transmit backup target data to the image forming apparatus selected as the data backup destination apparatus by the comparing-selecting portion.

According to a second aspect of the preferred embodiment of the present invention, a recording medium stores a data backup processing program for making a computer provided in a backup origin image forming apparatus execute the following steps, wherein the steps includes:

a step of obtaining output performance information of a plurality of other image forming apparatuses as backup destination candidate apparatuses connected via a network;

a step of comparing the obtained output performance information of each of the plurality of other image forming apparatuses and output performance information of the backup origin image forming apparatus and selecting an image forming apparatus having output performance equivalent to or better than the output performance of the backup origin image forming apparatus as a data backup destination apparatus from the plurality of other image forming apparatuses as the backup destination candidate apparatuses based on the comparison result; and

a step of transmitting backup target data to the image forming apparatus selected as the data backup destination apparatus by the comparing-selecting portion.

The above and/or other aspects, features and/or advantages of various embodiments will be further appreciated in view of the following description in conjunction with the accompanying figures. Various embodiments can include and/or exclude different aspects, features and/or advantages where applicable. In addition, various embodiments can combine one or more aspect or feature of other embodiments where applicable. The descriptions of aspects, features and/or advantages of particular embodiments should not be construed as limiting other embodiments or the claims.

### BRIEF DESCRIPTION OF THE DRAWINGS

The preferred embodiments of the present invention are shown by way of example, and not limitation, in the accompanying figures, in which:

FIG. 1 is a structural view showing an image forming system in which an image forming apparatus according to an embodiment of the present invention is used:

FIG. 2 shows a control block diagram of the image forming apparatus which is a backup origin image forming apparatus;

FIG. 3 shows a liquid crystal panel screen for selecting backup destination candidate image forming apparatuses by a user;

FIG. 4 is a table in which output performance information of each image forming apparatus is shown every item;

FIG. 5 is a table for explaining the conditions to be used when a comparing-selecting portion automatically selects a backup destination image forming apparatus;

FIG. 6 is a table for explaining another conditions to be used when a comparing-selecting portion automatically selects a backup destination image forming apparatus; and

FIG. 7 is a flowchart showing backup processing to be executed by a backup origin image forming apparatus.

### DETAILED DESCRIPTION OF THE PREFERRED EMBODIMENTS

In the following paragraphs, some preferred embodiments of the invention will be described by way of example and not limitation. It should be understood based on this disclosure that various other modifications can be made by those in the art based on these illustrated embodiments.

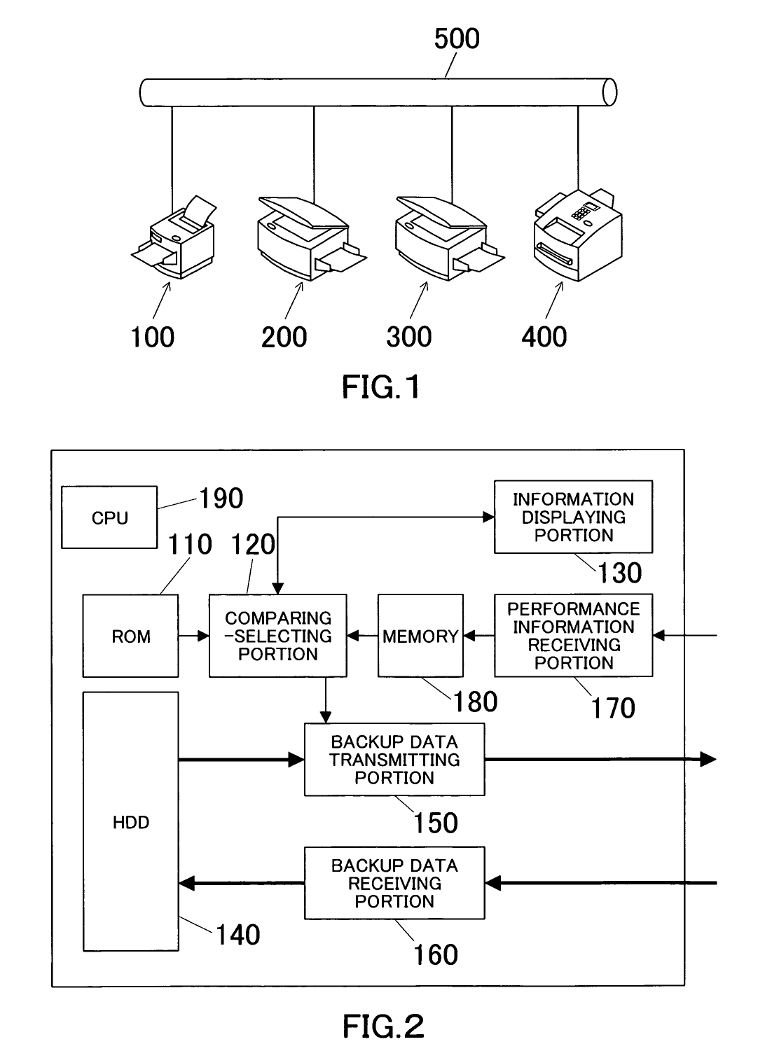

FIG. 1 shows an entire structural view of an image forming system in which an image forming apparatus according to one embodiment of the present invention is used.

The image forming system shown in FIG. 1 includes a plurality of image forming apparatuses 100 to 400 connected to the network 500. For example, it can be configured such that the image forming apparatus 100 is a printer, the image forming apparatuses 200 and 300 are copying machines, and the image forming apparatuses 400 is a complex machine equipped with a printer function, a copying function, a FAX function, etc.

In this embodiment, the following explanation will be directed to the case in which the data stored in the image forming apparatus 100 is to be duplicated on one of other image forming apparatuses 200 to 400.

FIG. 2 shows a control block diagram of the image forming apparatus 100. It should be noted that this diagram only shows the elements related to the data backup control from the HDD.

The image forming apparatus 100 includes a ROM 110, a comparing-selecting portion 120, an information displaying portion 130, an HDD 140, a backup data transmitting portion 150, a backup data receiving portion 160, a performance information receiving portion 170, a memory 180, and a CPU 190.

The ROM 110 stores the performance information on the output of the backup origin image forming apparatus 100, i.e., the output performance information thereof (hereinafter the output performance may be simply referred to as “performance” as well as an operation program for the CPU 190.

The comparing-selecting portion 120 is configured to compare the output performance information of the other image forming apparatus 200 to 400 obtained via the network 500 and the output performance information of the backup origin image forming apparatus 100 to thereby select one of the other image forming apparatuses having output performance information equivalent to or more than the output performance of the backup origin image forming apparatus 100 as a date backup destination apparatus.

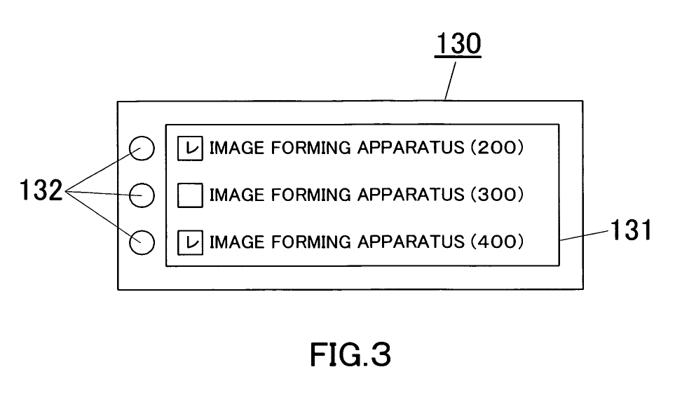

The information displaying portion 130, as shown in FIG. 3 for example, is equipped with a liquid crystal panel 131 of a touch panel type and an input control portion 132 consisting of push buttons. In this embodiment, as shown in FIG. 3, it is configured that all of the image forming apparatuses connected to the network 500 are displayed on the liquid crystal panel 131 so that a user can set whether or not displayed image forming apparatuses are specified as backup destination image forming apparatuses by operating the input control portion 132. The illustrated example shown in FIG. 3 shows that the checked image forming apparatuses are specified as candidate apparatuses, and the aforementioned comparing-selecting portion 120 selects a backup destination apparatus among the specified candidate apparatuses.

By configuring such that a user can set whether or not displayed image forming apparatuses are specified as backup destination image forming apparatuses, in the case where the user desires to select the backup destination image forming apparatuses located on the same floor as the user's floor, the user can simply specify only the image forming apparatuses located on the same floor as candidate apparatuses by excluding image forming apparatuses located on the other floors. Accordingly, the user's intention regarding the backup destination can be reflected, which in turn can increase the user's convenience. Configuring such that a user can search image forming apparatuses belonging to the same group such as image forming apparatuses located on the same floor further enhances the user's convenience.

The liquid crystal panel 131 of the information displaying portion 130 is capable of displaying the list of the output performance information of the backup origin image forming apparatus 100 and other image forming apparatuses 200 to 400, so that a user can select a backup destination image forming apparatus in its own judgment by operating the input control portion 132 and the touch panel while considering the output performance information shown in the list. Thus, as to a backup destination selection method, the user now can have two options, one is an automatic selection by the comparing-selecting portion 120 and the other is a manual selection by the user himself/herself, resulting in increased selection freedom.

When a backup destination is manually selected by a user, the comparing-selecting portion 120 sets the image forming apparatus selected by the user as a backup destination image forming apparatus.

Furthermore, it is also configured such that a user can change the conditions of automatically selecting a backup destination by the comparing-selecting portion 120 via the information displaying portion 130. This will be detailed later.

The HDD 140 stores various data including image data such as print data, and the entire or a part of the data stored in the HDD 140 will be transmitted as backup target data to a backup destination apparatus.

The backup data transmitting portion 150 is configured to transmit the backup target data stored in the HDD 140 to the backup destination image forming apparatus automatically selected by the comparing-selecting portion 120 or manually selected by the user. The backup receiving portion 160 is configured to receive the backup data transmitted from the aforementioned another image forming apparatus when the image forming apparatus 100 is selected as a backup destination apparatus by other image forming apparatuses 200 to 400. The received data will be stored in the HDD 140 as backup data.

The performance information receiving portion 170 is configured to receive and acquire output performance information from other image forming apparatus 200 to 400 connected to the network 500 via the network 500. Such output performance information acquiring can be performed regularly or performed at the time of selecting a backup destination apparatus.

The memory 180 is configured to store output performance information of other image forming apparatuses 200 to 400 obtained by the performance information receiving portion 170. The comparing-selecting portion 120 is configured to call up the output performance information of other image forming apparatuses 200 to 400 stored in the memory 180 and the performance information of the backup origin image forming apparatus 100 stored in the ROM 110 to compare them or display them on the information displaying portion 130.

The CPU 190 is configured to entirely control the image forming apparatus 100 including each portion of the control brocks shown in FIG. 2. This CPU 190 operates based on the program stored in a recording medium such as the ROM 110. In this embodiment, the comparing-selecting portion 120 is constituted as a part of the function of the CPU 190.

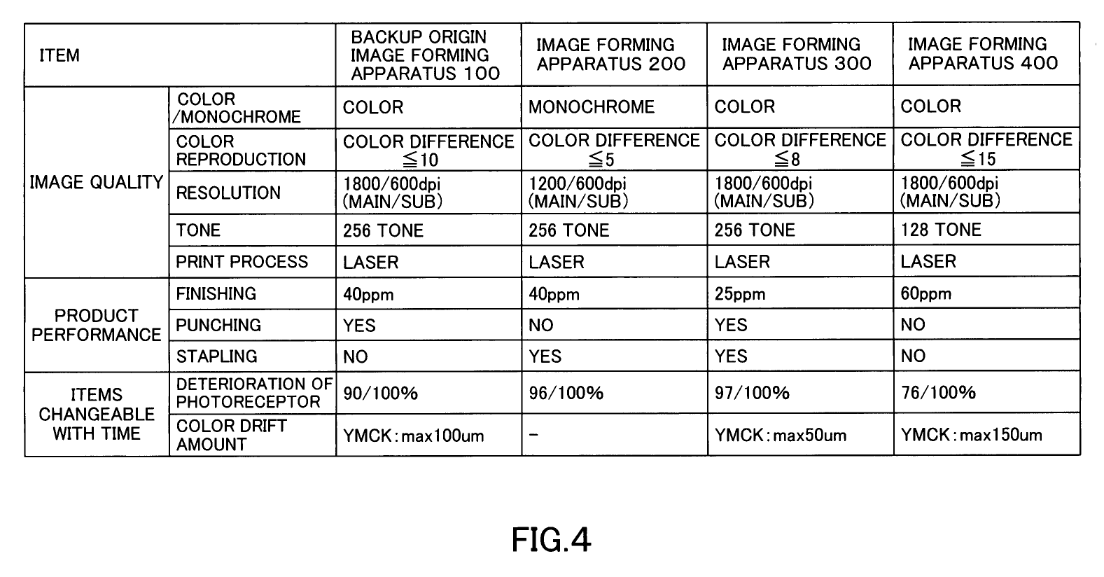

FIG. 4 shows a table in which output performance information of each of the image forming apparatuses 100 to 400 is shown every item. As to the items, the following items are listed in this embodiment. That is, as image quality items, color machine or monochrome machine (hereinafter “color/monochrome”, color reproduction, resolution, tone, and print process are listed. As product performance items, finishing, punching, and stapling are listed. As items changeable with time, deterioration of photoreceptor and color drift amount are listed.

In cases where a user selects a backup destination apparatus, as shown in Table of FIG. 4, each item of each image forming apparatus 100 to 400 is shown on the liquid crystal panel 131 of the information displaying portion 130 in a manner such that the items can be compared each other. Referring to the table, a user can select a desired image forming apparatus as a backup destination apparatus via the input control portion 132.

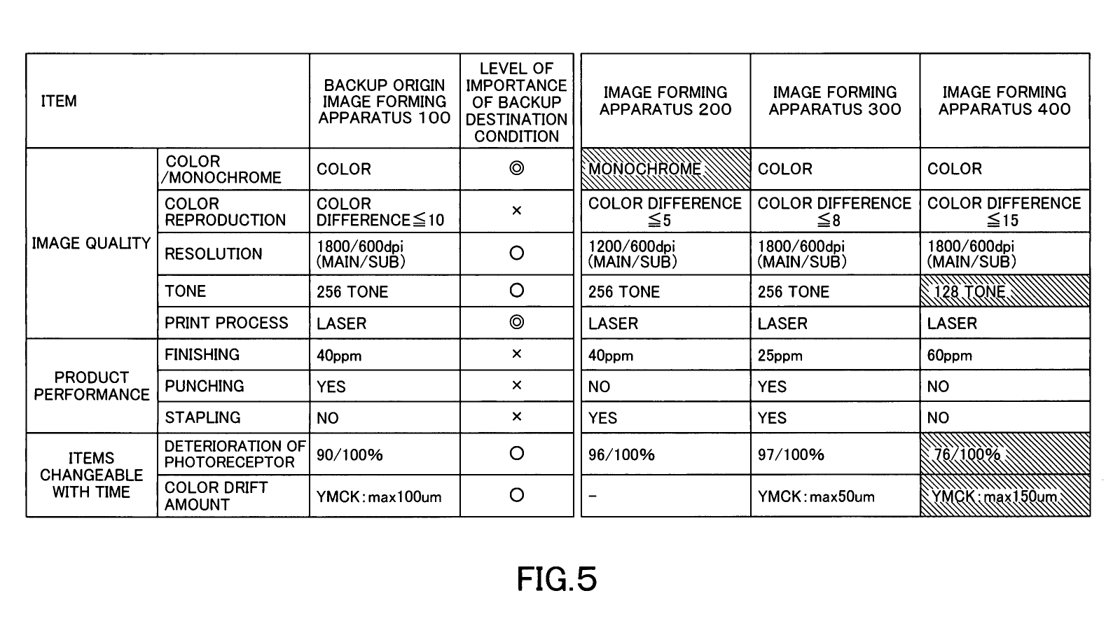

FIG. 5 shows a table for explaining the conditions to be used when a comparing-selecting portion 120 automatically selects a backup destination image forming apparatus.

In this table, although the output performance items are the same as those shown in FIG. 4, the level of importance is set to each item. In FIG. 5, “⊚” denotes “same level or better is essential,” “∘” denotes “same level or better is preferable,” “x” denotes “no condition.” The items on “color/monochrome,” “resolution,” “tone,” “print process,” “deterioration of photoreceptor,” and “color drift amount” are especially related to print quality among the output performance information. If these conditions are not met, satisfactory print quality cannot be obtained at the time of the printing at the backup destination apparatus. Therefore, these are listed as a high level of importance.

It can be configured such that the level of importance of each of these items can be arbitrarily changed by a user via the liquid crystal panel 131 of the information displaying portion 130 and the input operation portion 132.

The comparing-selecting portion 120 compares the output performance information of the backup origin image forming apparatus 100 and the output performance information of other image forming apparatuses 200 to 400 every item to thereby select one of the image forming apparatus which best meets the conditions as a backup destination apparatus.

In the example shown in FIG. 5, with respect to the image forming apparatus 100 which is a backup origin apparatus, among the image forming apparatuses 200 to 400 as backup destination candidate apparatuses, the image forming apparatus 200 fails to meet the condition of “color apparatus” as the essential condition “⊚” (same level or better is essential). The image forming apparatus 400 is inferior to the backup origin image forming apparatus 100 in terms of the conditions of “tone,” “deterioration of photoreceptor,” and “color drift amount” among the preferable condition “∘” (same level or better is preferable). Accordingly, in this example, the image forming apparatus 300 is selected as a backup destination apparatus. Please note that the shaded items in FIG. 5 denote items failing to meet the essential condition “⊚” (same level or better is essential) or the preferable condition “∘” (same level or better is preferable).

As explained above, the output performance information is classified into a plurality of items to which the level of importance is allotted, and the output performance information of each image forming apparatus 200 to 400 and the output performance information of the backup origin image forming apparatus 100 are compared every item. Then, an image forming apparatus which meets the output performance of the backup origin image forming apparatus 100 as to the items of high level importance will be selected as a backup destination apparatus. Accordingly, the comparison processing can be simplified and objective comparison can be performed, which enables assured selection of the most appropriate backup destination apparatus.

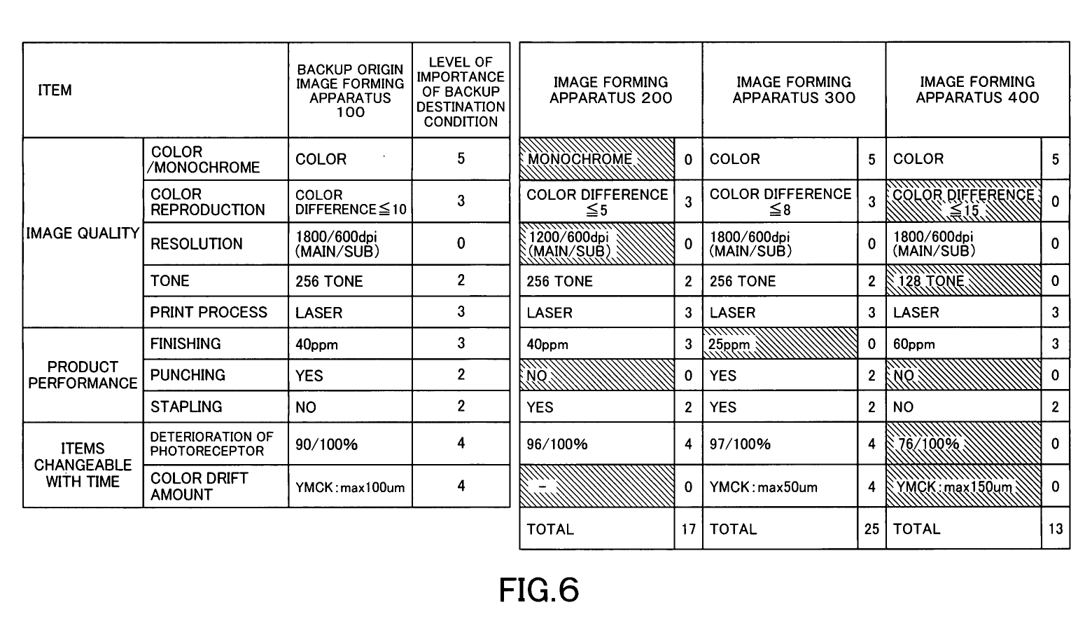

FIG. 6 is a table for explaining another example of conditions to be used when a comparing-selecting portion 120 automatically selects a backup destination image forming apparatus.

In this table, although the output information items are the same as those shown in FIGS. 4 and 5, each item is allotted by the numeral of 0 to 5 showing the level of importance (larger numeral denotes higher level of importance). In other words, each item is classified by the weight. It can be configured such that the weighting of each item is capable of being arbitrarily changed by a user via the crystal panel 131 of the information displaying portion 130 and the input operation portion 132.

The comparing-selecting portion 120 compares the output performance information of the backup origin image forming apparatus 100 and the output performance information of each of other image forming apparatuses 200 to 400 as backup candidate apparatuses every item, adds the weighting point only on the items of other image forming apparatuses whose performance is equivalent to or better than the performance of the backup origin image forming apparatus 100, and add the points on every item of each image forming apparatus to select an image forming apparatus (image forming apparatus 300 in the example shown in FIG. 6) with the largest total points as a backup destination apparatus.

As explained above, the output performance information is classified into a plurality of items whose level of importance is shown by numeral, the output performance information of each image forming apparatus 200 to 400 and the output performance information of the backup origin image forming apparatus 100 are compared every item, the total points on the item which meets the output performance of the backup origin image forming apparatus 100 are calculated every image forming apparatus 200 to 400, and an image forming apparatus having the highest points is selected as a backup destination apparatus. Therefore, a more appropriate image forming apparatus can be selected as a backup destination apparatus.

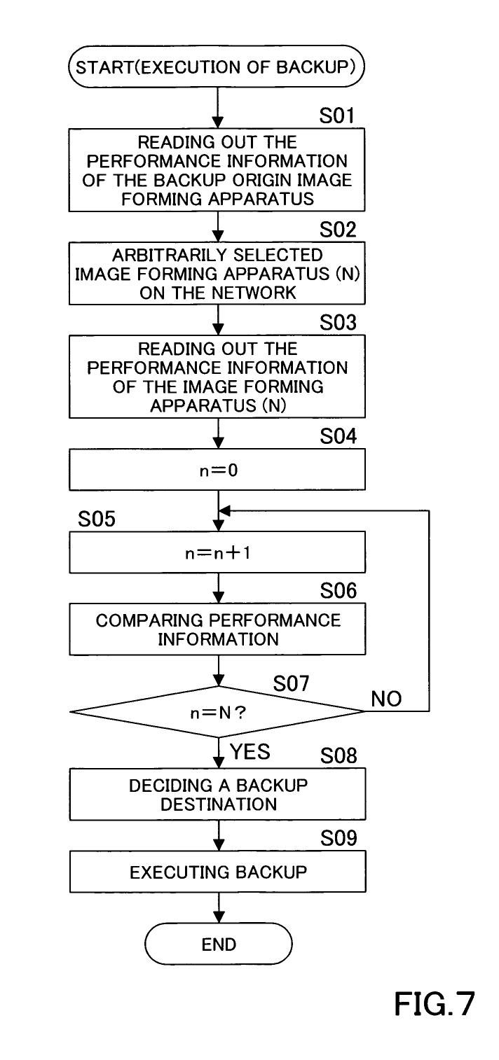

Next, the backup execution processing of the image forming apparatus 100 will be explained with reference to the flowchart shown in FIG. 7. This processing will be performed by the CPU 190 executing the program stored in a recording medium such as the ROM 110.

In the following explanation, it is assumed that a plurality (N pieces) of image forming apparatuses as backup destination candidate apparatuses are specified by a user in advance. It is further assumed that the output performance information of each of image forming apparatuses as backup destination candidate apparatuses is regularly obtained via the performance information receiving portion 170 to be stored in the memory 180 in an updated manner.

First, at Step S01, the output performance information of the backup origin image forming apparatus 100 is read out from the ROM 110. Then, at Step S02, a plurality (“N” pieces) of image forming apparatuses are set as backup destination candidate apparatuses. Thereafter, at Step S03, the output performance information of each of the N pieces of image forming apparatuses is read out from the memory 180.

Subsequently, as to each of the N pieces of image forming apparatuses as backup destination candidate apparatuses, the output performance information of each apparatus and the output performance information of the backup origin image forming apparatus 100 are compared every item in order. In detail, at Step S04, the parameter “n” showing the number of image forming apparatuses as backup destination candidate apparatuses is set to “0.” Then, at Step S05, “1” is added to “n,” then at Step S06, the output performance information is compared at to the first image forming apparatus.

Next, at Step S07, it is discriminated whether [n=N], in other words, whether comparison of output performance information as to all of the backup destination candidate image forming apparatus has been completed.

If it is not [n=N] (NO at Step S07), the routine returns to Step S05 and the parameter n is incremented by 1. Then, as to the following image forming apparatus, comparison of the output performance information is performed. Until completion of the comparison on all of the image forming apparatuses as backup destination candidate apparatuses, the processing of Step S05 to Step S07 will be repeated.

After the completion of the comparison of the output performance information as to all of the image forming apparatuses as backup destination candidate apparatuses (YES at Step S07), at Step S08, a backup destination apparatus is decided based on the comparison results.

Then, at Step S09, the backup target data is read out from the HDD 140 and transmitted to the aforementioned decided image forming apparatus (e.g., image forming apparatus 300).

The backup destination image forming apparatus 300 received the backup target data stores and backs up the data in its HDD 140. In cases where the backup origin image forming apparatus 100 becomes unavailable because of malfunction, etc., or data is destroyed or lost, the backup data can be outputted from the backup destination image forming apparatus 300. At this time, since an image forming apparatus 300 having the same or better output performance as compared to the backup origin image forming apparatus 100 is selected as a backup destination image forming apparatus, it becomes possible to obtain an output result equivalent to or better than the output result to be obtained by the backup origin image forming apparatus 100.

Especially, in the case where an image forming apparatus having performance equivalent to or better than the performance of the backup origin image forming apparatus 100 as to print quality is selected as a backup destination apparatus, printing with quality equivalent to or better than the quality to be obtained by the backup origin image forming apparatus 100 can be reproduced. Furthermore, in cases where an image forming apparatus having performance equivalent to or better than the performance of the backup origin image forming apparatus 100 as to the product performance is selected, convenience equivalent to or better than the convenience of the backup origin image forming apparatus 100 can be secured.

Although the above explanation is directed to one embodiment, it should be noted that the present invention is not limited to the embodiment. For example, in the above embodiment, the output performance information of other image forming apparatuses 200 to 400 is obtained via the network 500 regularly or at the time of selecting a backup destination apparatus. However, the information can be inputted via the information displaying portion 130 or can be stored in the memory 180 in advance. However, it is preferable to obtain the information via the network 500 since the most recent output performance information can be obtained and it is able to easily cope with the increased backup destinations due to the newly connected image forming apparatuses.

Furthermore, performance information is not limited to the items shown in Tables 4 to 6 and items to be compared are also not limited. For example, as print quality, only the items of “color/monochrome” can be compared.

In the aforementioned embodiment, a user can specify backup destination candidate apparatuses, and a user can manually select a backup destination apparatus. However, one of these functions or both of them can be omitted.

While the present invention may be embodied in many different forms, a number of illustrative embodiments are described herein with the understanding that the present disclosure is to be considered as providing examples of the principles of the invention and such examples are not intended to limit the invention to preferred embodiments described herein and/or illustrated herein.

While illustrative embodiments of the invention have been described herein, the present invention is not limited to the various preferred embodiments described herein, but includes any and all embodiments having equivalent elements, modifications, omissions, combinations (e.g., of aspects across various embodiments), adaptations and/or alterations as would be appreciated by those in the art based on the present disclosure. The limitations in the claims are to be interpreted broadly based on the language employed in the claims an not limited to examples described in the present specification or during the prosecution of the application, which examples are to be construed as non-exclusive. For example, in the present disclosure, the term “preferably” is non-exclusive and means “preferably, but not limited to.” In this disclosure and during the prosecution of this application, means-plus-function or step-plus-function limitations will only be employed where for a specific claim limitation all of the following conditions are present in that limitation: a) “means for” or “step for” is expressly recited; b) a corresponding function is expressly recited; and c) structure, material or acts that support that structure are not recited. In this disclosure and during the prosecution of this application, the terminology “present invention” or “invention” may be used as a reference to one or more aspect within the present disclosure. The language present invention or invention should not be improperly interpreted as an identification of criticality, should not be improperly interpreted as applying across all aspects or embodiments (i.e., it should be understood that the present invention has a number of aspects and embodiments), and should not be improperly interpreted as limiting the scope of the application or claims. In this disclosure and during the prosecution of this application, the terminology “embodiment” can be used to describe any aspect, feature, process or step, any combination thereof, and/or any portion thereof, etc. In some examples, various embodiments may include overlapping features. In this disclosure and during the prosecution of this case, the following abbreviated terminology may be employed: “e.g.” which means “for example;” and “NB” which means “note well.”

What is claimed is:

1. An image forming apparatus as a backup origin image forming apparatus, comprising:
a storing portion configured to store output performance information of a plurality of other image forming apparatuses as backup destination candidate apparatuses connected to the backup origin image forming apparatus via a network;
a comparing-selecting portion configured to compare the stored output performance information of each of the plurality of other image forming apparatuses and output performance information of the backup origin image forming apparatus and select an image forming apparatus having output performance equivalent to or better than the output performance of the backup origin image forming apparatus as a data backup destination apparatus from the plurality of other image forming apparatuses as the backup destination candidate apparatuses based on the comparison result; and
a transmitting portion configured to transmit backup target data to the image forming apparatus selected as the data backup destination apparatus by the comparing-selecting portion.

2. The image forming apparatus as recited in claim 1, further comprising:
a displaying portion for displaying the output performance information of each of the plurality of other image forming apparatuses and the output performance information of the backup origin image forming apparatus; and
a setting portion for setting as the data backup destination apparatus the image forming apparatus selected by a user based on the displayed output performance information of each of the other image forming apparatuses and the output performance information of the backup origin image forming apparatus.

3. The image forming apparatus as recited in claim 1, further comprising an input portion capable of specifying two or more of the plurality of other image forming apparatuses as backup destination candidate apparatuses by a user,
wherein the comparing-selecting portion selects the data backup destination apparatus from the two or more of the plurality of other image forming apparatuses specified by the user.

4. The image forming apparatus as recited in claim 1, wherein the output performance information includes information on print quality.

5. The image forming apparatus as recited in claim 1, wherein the output performance information is classified into a plurality of items to which level of importance is allotted, respectively, and wherein the comparing-selecting portion compares the output performance information of each of the plurality of other image forming apparatuses and the output performance information of the backup origin image forming apparatus every item to thereby select one of the plurality of other image forming apparatuses which meets items of higher level of importance of the output performance of the backup origin image forming apparatus as the data backup destination apparatus.

6. The image forming apparatus as recited in claim 1, wherein the output performance information is classified into a plurality of items to which level of importance is allotted by points, respectively, and wherein the comparing-selecting portion compares the output performance information of each of the plurality of other image forming apparatuses and the output performance information of the backup origin image forming apparatus every item, calculates total points on the items meeting the output performance of the backup origin image forming apparatus every other image forming apparatus, and selects one of the plurality of other image forming apparatuses based on the result of the calculation as the data backup destination apparatus.

7. The image forming apparatus as recited in claim 1, further comprising a receiving portion for receiving the output performance information of the plurality of other image forming apparatuses as the backup destination candidate apparatuses via the network.

8. A recording medium in which a data backup processing program for making a computer provided in a backup origin image forming apparatus execute the following steps is stored,
wherein the steps includes:
a step of obtaining output performance information of a plurality of other image forming apparatuses as backup destination candidate apparatuses connected via a network;
a step of comparing the obtained output performance information of each of the plurality of other image forming apparatuses and output performance information of the backup origin image forming apparatus and selecting an image forming apparatuses having output performance equivalent to or better than the output performance of the backup origin image forming apparatus as a data backup destination apparatus from the plurality of other image forming apparatuses as the backup destination candidate apparatuses based on the comparison result; and
a step of transmitting backup target data to the image forming apparatus selected as the data backup destination apparatus by the comparing-selecting step.

9. The recording medium as recited in claim 8, wherein the data backup processing program further makes the computer execute the steps of:
displaying the output performance information of each of the plurality of other image forming apparatuses and the output performance information of the backup origin image forming apparatus on a display device; and
setting as the data backup destination apparatus the image forming apparatus selected by a user based on the displayed output performance information of each of the other image forming apparatuses and the output performance information of the backup origin image forming apparatus.

10. The recording medium as recited in claim 8, wherein the data backup processing program further makes the computer execute the steps of:
setting as backup destination candidate apparatuses two or more of the plurality of other image forming apparatuses specified by a user,
selecting the data backup destination apparatus from the two or more of the plurality of other image forming apparatuses specified by the user.

11. The recording medium as recited in claim 8, wherein the output performance information includes information on print quality.

12. The recording medium as recited in claim 8, wherein the output performance information is classified into a plurality of items to which level of importance is allotted, respectively, and wherein the comparing-selecting step compares the output performance information of each of the plurality of other image forming apparatuses and the output performance information of the backup origin image forming apparatus every item to thereby select one of the plurality of other image forming apparatuses which meets items of higher level of importance of the output performance of the backup origin image forming apparatus as the data backup destination apparatus.

13. The recording medium as recited in claim 8, wherein the output performance information is classified into a plurality of items to which level of importance is allotted by points, respectively, and wherein the comparing-selecting step compares the output performance information of each of the plurality of other image forming apparatuses and the output performance information of the backup origin image forming apparatus every item, calculates total points on the items meeting the output performance of the backup origin image forming apparatus every other image forming apparatus, and selects one of the plurality of other image forming apparatuses based on the result of the calculation as the data backup destination apparatus.

14. The recording medium as recited in claim 8, wherein the data backup processing program further makes the computer execute a step of receiving the output performance information of the plurality of other image forming apparatuses as the backup destination candidate apparatuses via the network.
